(19) United States
(12) Patent Application Publication
(10) Pub. No.: US 2012/0308951 A1
(43) Pub. Date: Dec. 6, 2012

(54) COAL DECOMPOSITION EQUIPMENT

(76) Inventors: Shucheng Zhu, Nanyang (CN); Xibin Wang, Nanyang (CN); Xiangyun Huang, Nanyang (CN); Guochao Cao, Nanyang (CN); Wei Liu, Nanyang (CN)

(21) Appl. No.: 13/578,630

(22) PCT Filed: Sep. 17, 2010
(86) PCT No.: PCT/CN2010/077020

§ 371 Date: Aug. 13, 2012

(30) Foreign Application Priority Data
Aug. 19, 2010 (CN) 201010262786.6

(51) Int. Cl. F27B 5/16

(52) U.S. Cl. 432/200

(57) ABSTRACT

The invention discloses a coal decomposition equipment including an airtight kiln body with an inlet and an outlet, wherein a flame gas pipeline heating facility is set in the kiln body and a channel for impelling and decomposing coal is formed between the flame gas pipeline heating facility and an inner wall of the kiln body; and a coal decomposition gas collecting pipe is provided on the kiln body to communicate with the channel. Since the present invention makes the vast thermal conduction produced by the flame gas pipeline heating facility and radiate to the coal power in the coal substance impel decomposition channel. The pulverized coal fully absorbs the heat so as to be heated and decomposed to the gas, coal tar gas and coal with a higher heat-value in the channel.

### FIELD OF THE INVENTION

The invention relates to comprehensive utilization of coal substance for saving energy and emission reduction, particularly to a coal decomposition equipment.

### BACKGROUND OF THE INVENTION

In conventional technology, coal is used to produce coal gas, natural gas, or used to produce gas by coking at high temperature, medium temperature or low temperature. However, the above-mentioned technology is required to block pulverized coal or sift lamp coal, as a result, it increases the cost of raw material, or cause the produced gas without a high heat value, a big additional value, and a significant economy and social benefits. The heating methods of furnace can be classified as external-heating style, internal heating style and hybrid-heating style. Specifically, the heating medium in external-heating furnace is not contact directly with raw materials and heat is introduced from furnace wall. The heating medium in the internal-heating furnace contacts with the raw materials directly, and the heating methods are classified as solid heat carrier style and gas heat carrier style according to different heat mediums.

A method in internal heating style and gas heat carrier style is a typical method used in the industry. The method uses a vertical continuous furnace in internal heating style and gas heat carrier style, which includes three parts from top to bottom: a drying section, a decomposition section and a cooling section. Lignite coals or their compressed blocks (about 25˜60 mm) move from top to bottom to countercurrent contact with the combustion gas directly so as to be heated for decomposition at low temperature. When a moisture content of raw material in furnace roof is about 15%, the raw material should be dried in the drying section to attain a moisture content below 1.0%, and the upstream hot combustion gas at about 250 degrees centigrade is cooled to a temperature at 80˜100 degrees centigrade. Then, the dried raw material is heated to about 500 degrees centigrade by the oxygen-free combustion gas at 600˜700 degrees centigrade in the decomposition section to be decomposed; The hot gas is cooled to about 250 degrees centigrade, and the produced semi-coke is transferred to the cooling section and cooled by cool gas. Then, the semi-coke is discharged and further cooled by water and air. The volatiles escaped from the decomposition section are processed in condensation and cooling steps, etc to attain tar and pyrolysis water. This kind of furnace has ever built in the Germany, United States, Soviet Union, Czechoslovakia, New Zealand and Japan.

The method in internal heating style and solid heat carrier style is a typical method of internal heating style. The raw materials are lignite coal, non-caking coal, weakly-caking coal and oil shale. In the 1950s, there is an intermediate testing device built with a processing capacity of 10 t/h coal in Dorsten of Federal Republic of Germany, and the used heat carrier are solid particles (small ceramic balls, sands or semi-cokes). Since the process product gas does not include exhaust gas, the equipment for later processing system has a smaller size and the gas has a higher heat value up to 20.5˜40.6 MJ/m3. The method has a large processing capacity because of its large temperature difference, small particles and fast heat transfer. The attained liquid products have a lot and the yield can be 30% when processing high-volatile coal. The technical process of L-R method for low-temperature coal decomposition is firstly mixing the preheated small blocks of raw coals with the hot semi-coke from separator in the mixer so as to start a thermal decomposition. Then, they are falling into the buffer, and staying a certain time to complete the thermal decomposition. The semi-cokes from buffer come into the bottom of a riser, and are transmitted by hot air and being burned the residual carbon thereof in riser at the same time so as to raise the temperature, and then the semi-coke is introduced into the separator for gas-solid separation. After that, the semi-cokes are returned to the mixer, and so circulate. A high heat value gas can be attained from the escaped volatiles from the mixer after dedusting, condensation, cooling and recycling oils.

At present, there are two kinds of conventional coal decomposition equipments, one of which has an up-draft kiln structure. The up-draft kiln structure is used for combusting flue gas and combustible gases produced by coal, which has low gas purity and a low additional value, as well as partially discharge of gas. This results in a significant resources wasting and environmental pollution. Another kind of coal decomposition equipment has a shaft kiln structure. Under the structure, coal lumps are placed on clapboard with holes, and a heater is provided above the coal lumps. Because the coal lumps on the clapboard are accumulated to a certain thickness, so they cannot be uniformly heated and decomposed, and are required to be cyclically heated and decomposed by the decomposed gas. More importantly, since the large amount of holes for ventilation and circulatory function provided on the clapboard, pulverized coal can leak from the holes. To avoid the condition, it is necessary to process the pulverized coal into coal briquette when introducing it into the shaft kiln. Thus, it will increase the cost of pulverized coal decomposition, and reduce the economic benefits because the pulverized coal cannot be directly used for coal decomposition.

### SUMMARY OF THE INVENTION

To solve the above problems in prior arts, an object of the present invention is to provide a method and equipment for pulverized coal decomposition, which can decompose the pulverized coal directly and thus improving their overall utilization value and saving energy, and so as to enhance its economic and social benefits.

According to the present invention, a coal decomposition equipment comprises an airtight kiln body with an inlet and an outlet, wherein a flame gas pipeline heating facility is set in the kiln body and a channel for impelling and decomposing coal is formed between the flame gas pipeline heating facility and an inner wall of the kiln body; and a coal decomposition gas collecting pipe is provided on the kiln body to communicate with the channel.

According to an embodiment of the invention, the kiln body is a horizontal kiln.

According to another embodiment of the invention, the kiln body is an up-draft kiln.

According to an embodiment of the invention, the kiln body is a rotary kiln and an impelling board is set in an inner wall of the kiln body.

According to an embodiment of the invention, the flame gas pipeline heating facility comprises a fuel supply pipe, an air supply pipe, a combustor chamber and a flame gas radiating pipe.

According to an embodiment of the invention, the flame gas pipeline heating facility comprises a flame gas radiating pipe and a combustor chamber, and the combustor chamber communicates with the fuel supply pipe and the air supply pipe set outside of the kiln body.

According to an embodiment of the invention, the flame gas pipeline heating facility comprises a flame gas radiating pipe, which communicates with a combustor chamber, a fuel supply pipe and an air supply pipe set outside of the kiln body.

According to an embodiment of the invention, the flame gas radiating pipe consists of multiple parallel close-packed pipes.

According to another embodiment of the invention, the flame gas radiating pipe consists of tube mesh close-packed pipes.

According to the present invention, an entirely new heating method is introduced into pulverized coal decomposition field, so a large amount of heat produced by the flame gas pipeline heating facility are conducted and radiated to the pulverized coal in the channel. Thus, the pulverized coal can fully absorb the heat so as to be heated for being decomposed to the gas, coal tar and coal with high heat-value in the channel. The gas and coal tar gas communicate with a gas dedust and liquefaction facility outside of the kiln body through the coal decomposition gas collecting pipe, and the decomposed gas and coal tar gas are collected, dedusted, separated, and pressure liquefied by the gas dedust and liquefaction facility. The flame gas radiating pipe consists of multiple parallel close-packed pipes or tube mesh close-packed pipes so that the produced heat can be transferred to the pulverized coal more sufficiently. The decomposition equipment for coal disclosed by the present invention makes the decomposition and separation of the pulverized coal more fast and efficient so as to save and fully utilize energy and greatly increase the utilization rate and level of coal resources, thus it will produce a significant economic and social benefits for the entire society.

### BRIEF DESCRIPTION OF THE DRAWINGS

The accompanying drawings facilitate an understanding of the various embodiments of this invention. In such drawings:

FIG. 1 is a schematic diagram of a coal decomposition equipment to show its structure according to a first embodiment of the present invention;

FIG. 2 is a schematic diagram of a coal decomposition equipment to show its structure according to a second embodiment of the present invention;

FIG. 3 is a cross-sectional view of FIG. 2 taken along line A-A;

FIG. 4 is a schematic diagram of a coal decomposition equipment to show its structure according to a third embodiment of the present invention.

### DETAILED DESCRIPTION OF THE INVENTION

### Embodiment 1

Referring to FIG. 1, a coal decomposition equipment comprises an airtight kiln body 1 with coal inlet 2 and coal outlet 3. The kiln body 1 is a horizontal and rotary kiln. A flame gas pipeline heating facility is set in the kiln body 1 and a channel 4 for impelling and decomposing coal is formed between the flame gas pipeline heating facility and an inner wall of the kiln body. A coal decomposition gas collecting pipe 5 is provided on the kiln body 1 to communicate with the channel 4, and an impelling board 10 is set in the inner wall of the kiln body 1. The flame gas pipeline heating facility includes a flame gas heat dissipation pipe 6 and a combustor chamber 7. The combustor chamber 7 communicates with a fuel supply pipe 8 and an air supply pipe 9 which are both set outside of the kiln body 1. The fuel in the fuel supply pipe 8 and the air in the air supply pipe 9 are mixed combustion in the combustor chamber 7, and the produced the high temperature flame gas come into the flame gas heat dissipation pipe 6, then the flame gas heat dissipation pipe 6 transfers the heat to the pulverized coal in the channel 4. The pulverized coal fully absorbs the heat so as to be heated and decomposed to the gas, coal tar gas and coal with a higher heat-value in the channel 4. The gas and coal tar gas communicate with a gas dedust and liquefaction facility outside of the kiln body 1 through the coal decomposition gas collecting pipe 5, and the decomposed gas and coal tar gas are collected, dedusted, separated, and pressure liquefied by the gas dedust and liquefaction facility. The coals with higher heat-value are collected through the coal outlet 3.

### Embodiment 2

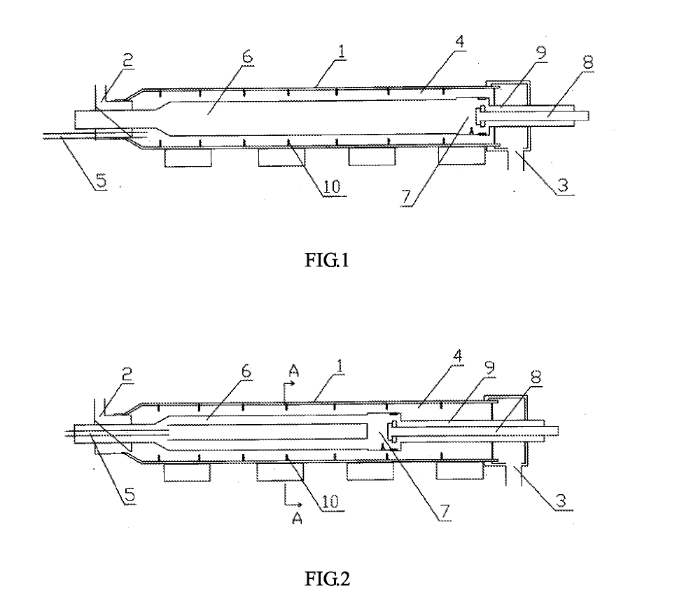

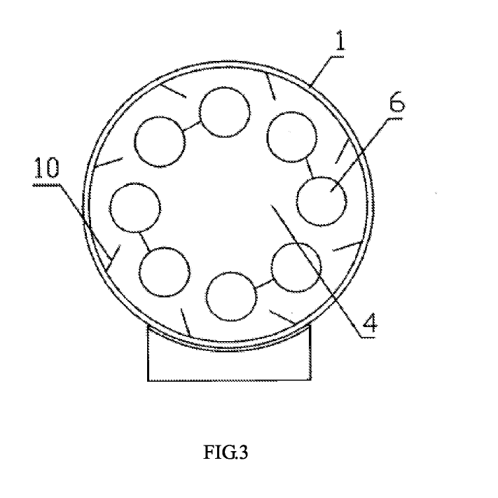

Referring to FIG. 2 and FIG. 3, a coal decomposition equipment comprises an airtight kiln body 1 with an inlet 2 and an outlet 3. The kiln body 1 is a horizontal and rotary kiln. A flame gas pipeline heating facility is set in the kiln body 1 and a channel 4 for impelling and decomposing coal is formed between the flame gas pipeline heating facility and an inner wall of the kiln body. A coal decomposition gas collecting pipe 5 is provided on the kiln body 1 to communicate with the channel 4, and an impelling board 10 is set in the inner wall of the kiln body 1. The flame gas pipeline heating facility includes a flame gas heat dissipation pipe 6 and a combustor chamber 7. The flame gas heat dissipation pipe 6 and the combustor chamber 7 communicate with a fuel supply pipe 8 and an air supply pipe 9. The flame gas heat dissipation pipe consists of multiple parallel close-packed pipes or tube mesh close-packed pipes so that the produced heat will be sufficiently transferred to the pulverized coal. The fuel in the fuel supply pipe 8 and the air in the air supply pipe 9 are mixed combustion in the combustor chamber 7, and the produced the high temperature flame gas come into the flame gas heat dissipation pipe 6, then the flame gas heat dissipation pipe 6 transfers the heat to the pulverized coal in the channel 4. The pulverized coal fully absorbs the heat so as to be heated and decomposed to the gas, coal tar gas and coal with a higher heat-value in the channel 4. The gas and coal tar gas communicate with a gas dedust and liquefaction facility outside of the kiln body 1 through the coal decomposition gas collecting pipe 5, and the decomposed gas and coal tar gas are collected, dedusted, separated, and pressure liquefied by the gas dedust and liquefaction facility. The coals with higher heat-value are collected through the coal outlet 3.

### Embodiment 3

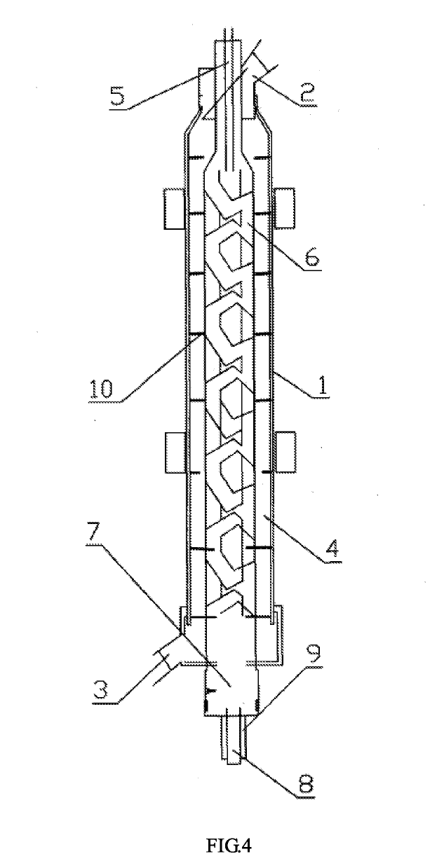

Referring to FIG. 4, a coal decomposition equipment comprises an airtight kiln body 1 with an inlet 2 and an outlet 3. The kiln body 1 is an up-draft and rotary kiln. A flame gas pipeline heating facility is set in the kiln body 1 and a channel 4 for impelling and decomposing coal is formed between the flame gas pipeline heating facility and an inner wall of the kiln body. A coal decomposition gas collecting pipe 5 is provided on the kiln body 1 to communicate with the channel 4, and an impelling board 10 is set in the inner wall of the kiln body 1. The flame gas pipeline heating facility includes a flame gas heat dissipation pipe 6. The flame gas heat dissipation pipe 6 communicates with a combustor chamber 7, a fuel supply pipe 8 and an air supply pipe 9, which are all set outside of the kiln body 1. The flame gas heat dissipation pipe consists of multiple parallel close-packed pipes or tube mesh close-packed pipes so that the produced heat will be sufficiently transferred to the pulverized coal. The fuel in the fuel supply pipe 8 and the air in the air supply pipe 9 are mixed combustion in the combustor chamber 7, and the produced the high temperature flame gas come into the flame gas heat dissipation pipe 6, then the flame gas heat dissipation pipe 6 transfers the heat to the pulverized coal in the channel 4. The pulverized coal fully absorbs the heat so as to be heated and decomposed to the gas, coal tar gas and coal with a higher heat-value in the channel 4. The gas and coal tar gas communicate with a gas dedust and liquefaction facility outside of the kiln body 1 through the coal decomposition gas collecting pipe 5, and the decomposed gas and coal tar gas are collected, dedusted, separated, and pressure liquefied by the gas dedust and liquefaction facility.

1. A coal decomposition equipment comprising:
an airtight kiln body with an inlet and an outlet, wherein a flame gas pipeline heating facility is set in the kiln body and a channel for impelling and decomposing coal is formed between the flame gas pipeline heating facility and an inner wall of the kiln body; and a coal decomposition gas collecting pipe is provided on the kiln body to communicate with the channel.

2. The coal decomposition equipment according to claim 1, wherein the kiln body is a horizontal kiln.

3. The coal decomposition equipment according to claim 1, wherein the kiln body is an up-draft kiln.

4. The coal decomposition equipment according to claim 1, wherein the kiln body is a rotary kiln and an impelling board is set in an inner wall of the kiln body.

5. The coal decomposition equipment according to claim 1 4 wherein the flame gas pipeline heating facility comprises a fuel supply pipe, an air supply pipe, a combustor chamber and a flame gas radiating pipe.

6. The coal decomposition equipment according to claim 1 wherein the flame gas pipeline heating facility comprises a flame gas radiating pipe and a combustor chamber, and the combustor chamber communicates with the fuel supply pipe and the air supply pipe set outside of the kiln body.

7. The coal decomposition equipment according to claim 1 wherein the flame gas pipeline heating facility comprises a flame gas radiating pipe, which communicates with a combustor chamber, a fuel supply pipe and an air supply pipe set outside of the kiln body.

8. The coal decomposition equipment according to claim 1 wherein the flame gas radiating pipe consists of multiple parallel close-packed pipes.

9. The coal decomposition equipment according to claim 5, wherein the flame gas radiating pipe consists of multiple parallel close-packed pipes.

10. The coal decomposition equipment according to claim 1 wherein the flame gas radiating pipe consists of tube mesh close-packed pipes.

11. The coal decomposition equipment according to claim 2 wherein the flame gas pipeline heating facility comprises a fuel supply pipe, an air supply pipe, a combustor chamber and a flame gas radiating pipe.

12. The coal decomposition equipment according to claim 3 wherein the flame gas pipeline heating facility comprises a fuel supply pipe, an air supply pipe, a combustor chamber and a flame gas radiating pipe.

13. The coal decomposition equipment according to claim 4 wherein the flame gas pipeline heating facility comprises a fuel supply pipe, an air supply pipe, a combustor chamber and a flame gas radiating pipe.

14. The coal decomposition equipment according to claim 2, wherein the flame gas pipeline heating facility comprises a flame gas radiating pipe and a combustor chamber, and the combustor chamber communicates with the fuel supply pipe and the air supply pipe set outside of the kiln body.

15. The coal decomposition equipment according to claim 3, wherein the flame gas pipeline heating facility comprises a flame gas radiating pipe and a combustor chamber, and the combustor chamber communicates with the fuel supply pipe and the air supply pipe set outside of the kiln body.

16. The coal decomposition equipment according to claim 4, wherein the flame gas pipeline heating facility comprises a flame gas radiating pipe and a combustor chamber, and the combustor chamber communicates with the fuel supply pipe and the air supply pipe set outside of the kiln body.

17. The coal decomposition equipment according to claim 2, wherein the flame gas pipeline heating facility comprises a flame gas radiating pipe, which communicates with a combustor chamber, a fuel supply pipe and an air supply pipe set outside of the kiln body.

18. The coal decomposition equipment according to claim 3, wherein the flame gas pipeline heating facility comprises a flame gas radiating pipe, which communicates with a combustor chamber, a fuel supply pipe and an air supply pipe set outside of the kiln body.

19. The coal decomposition equipment according to claim 2, wherein the flame gas radiating pipe consists of multiple parallel close-packed pipes.

20. The coal decomposition equipment according to claim 2, wherein the flame gas radiating pipe consists of tube mesh close-packed pipes.
